(19) United States
(12) Patent Application Publication
(10) Pub. No.: US 2020/0129035 A1
(43) Pub. Date: Apr. 30, 2020

(54) Disposable Spray Nozzle

(71) Applicant: For Life Products, LLC, Miramar, FL (US)

(72) Inventors: Joseph A. McDonnell, Weston, FL (US); Dung T. Tran, Lauderhill, FL (US); Juan Jose Alvira Fernandez, Miramar, FL (US)

(21) Appl. No.: 16/173,375

(22) Filed: Oct. 29, 2018

(51) Int. Cl. A47L 13/22; B05B 15/60

(52) U.S. Cl. CPC A47L 13/22; B05B 15/60

(57) ABSTRACT

A disposable nozzle is disclosed herein. Among other features, the disposable nozzle comprises a hollow cylindrical body having an inlet upstream end configured to receive a flow of liquid and an outlet downstream end for distributing the flow of liquid in a desired spray pattern; and attachment means configured to removably couple the disposable nozzle to an spraying system.

### FIELD OF TECHNOLOGY

The present disclosure generally relates to a disposable spray nozzle design used in a liquid spraying system.

### BACKGROUND

Spray mops or cleaning solution dispensing mops have been used to clean various floor surfaces for many years. In some applications, a nozzle head may be used on a spray mop for maintaining fluid communication with a liquid source (e.g., a cleaning solution bottle) and distributing the liquid over an area through a spray opening. However, one of the most common and frustrating difficulties encountered during the use of this type mops is the tendency of the fluid conducting passages of the nozzle head, particularly the spray opening carrying and dispensing various concentrated chemical solutions, to become clogged. This condition may result from the build-up of particles of chemical solutions by corrosion of the passage walls of the nozzle head or an accretion or deposition of dirt, grime and particles of viscous chemical solutions within the passages. In many instances, regular cleaning and repair are difficult or unavailable due to the lack of access to these clogged portions of the nozzle head. As a result, partial blockages of passages of the nozzle head may result in an irregular and coarse spray of the spray mop, whereas full blockages may completely interrupt fluid flow rendering the spray mop inoperable. In fact, such blockages may occur in any liquid spraying system (e.g., a crop spraying system, fountain, humidifier, coating or paint spray) that uses a nozzle head for distributing liquid over an area through a spray opening.

Accordingly, there is a need for a nozzle head design used on a spraying system to accommodate the use of, e.g., more viscous or harsh chemical solutions and provide an easy and simple way for a user to replace a clogged nozzle head thereby improving the efficiency and extending the life of the spraying system.

### SUMMARY

The present disclosure discloses a disposable nozzle, comprising: a hollow cylindrical body having an inlet upstream end configured to receive a flow of liquid and an outlet downstream end for distributing the flow of liquid in a desired spray pattern; and attachment means configured to removably couple the disposable nozzle to an spraying system.

In one aspect, the attachment means may be configured to removably couple the disposable nozzle to the spraying system via a fluid passageway of the spraying system, wherein an outer diameter of the hollow cylindrical body is less than an inner diameter of the fluid passageway of the spraying system. The disposable nozzle may comprise a circular groove positioned near the inlet upstream end of the hollow cylindrical body for receiving an annular sealing member. The annular sealing member is configured to provide a tight seal engagement between the hollow cylindrical body and the fluid passageway of the spraying system and prevent liquid leakage downstream therefrom.

In another aspect, the attachment means may comprise a pair of radially extending and diametrically opposed stops positioned on a selected position on an outer surface of the hollow cylindrical body in a downstream direction of the annular sealing member. The fluid passageway of the spraying system may comprise a pair of diametrically spaced L-shaped slots, each L-shaped slot including a first portion that is substantially parallel to a longitudinal axis of the fluid passageway and a second portion implemented on a circumference of the fluid passageway. Further, the first portion of each L-shaped slot may comprise an opening for receiving each stop when the hollow cylindrical body of the disposable nozzle is inserted into the fluid passageway. The second portion of each L-shaped slot may comprise an end wall for locking and retaining each stop. A circumferential distance of the second portion of each L-shaped slot may be greater than or at least equal to that of each stop. A thickness of a cylindrical wall of the fluid passageway may progressively decrease from an upstream end towards a downstream end. A height of each stop of the hollow cylindrical body in a radial direction may be less than or equal to a thickness of the end wall of the second portion of a respective L-shaped slot.

In another aspect, the outlet downstream end of the hollow cylindrical body may comprise a nozzle opening for distributing the flow of liquid in the desired spray pattern. The outlet downstream end of the hollow cylindrical body may also comprise an outer cylindrical shell having a plurality of longitudinal ribs implemented thereon. The hollow cylindrical body of the disposable nozzle may be configured to have an internal diameter progressively decreasing from the inlet upstream end to the outlet downstream end.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplary pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates a multi-surface spray mop, according to an exemplary aspect;

FIG. 2 illustrates a multi-surface spray mop with a cleaning liquid bottle inserted into a bottle reservoir of the multi-surface spray mop, according to an exemplary aspect;

FIG. 3 illustrates a disposable nozzle positioned at a bottom portion of the bottle reservoir of the multi-surface spray mop, according to an exemplary aspect;

FIG. 4 illustrates a cross-sectional view of the disposable nozzle connecting with a water cover of the multi-surface spray mop, according to an exemplary aspect; and

FIG. 5 illustrates various components of the disposable nozzle and how the disposable nozzle connects with a fluid passageway of the water cover of the multi-surface spray mop, according to an exemplary aspect.

### DETAILED DESCRIPTION

Various aspects of the disclosure will be described with reference to the drawings, wherein like reference numerals are used to refer to like elements throughout. In the following description, for purposes of explanation, numerous specific details are set forth in order to promote a thorough understanding of one or more aspects of the disclosure. It may be evident in some or all instances, however, that any aspects described below can be practiced without adopting the specific design details described below.

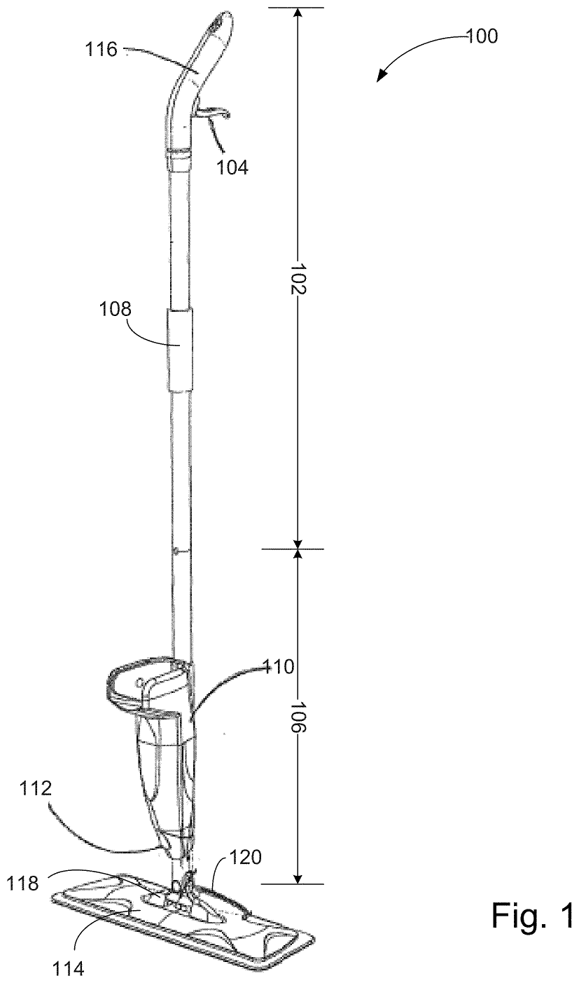

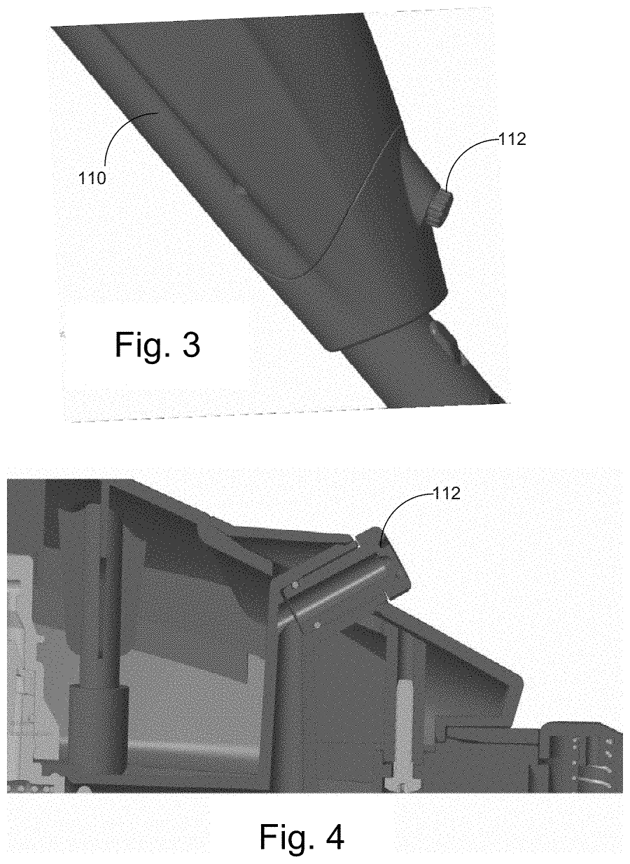

Referring to FIGS. 1-3, according to aspects of the present disclosure, a multi-surface spray mop 100 may include an upper pole section 102, a spray trigger 104, a lower pole section 106, a soft support grip portion 108 positioned on the shaft of the upper pole section 102, a bottle reservoir 110 with a directional mist nozzle 112 on its front surface, and a mop base 114. Such spray mop 100 may be used for dusting, scrubbing and cleaning various surfaces such as hardwood, laminate, vinyl, granite, stone, marble, tile floors, and carpet. Via, e.g., a lock notch or other suitable means, the upper pole section 102, the lower pole section 106, and the mop base 114 may be readily assembled together to form a mop having an integral elongated body and dissembled into separate pieces for easy storage. An angled ergonomic mop handle 116 may be provided at one distal end of the upper pole section 102 for a user to guide the spray mop 100 in a desired direction with reduced hand and wrist strain. The soft support grip portion 108 positioned on the shaft of the upper pole section 102 may provide a secondary handhold. The lower pole section 106 may comprise a first distal end for connecting with the upper pole section 102, and a second distal end having a protruding coupling portion for connecting with the mop base 114 or a brush. The mop base 114 includes a swivel joint 118 that allows a user to use the handle of the mop 100 to move back and forth along a desired path.

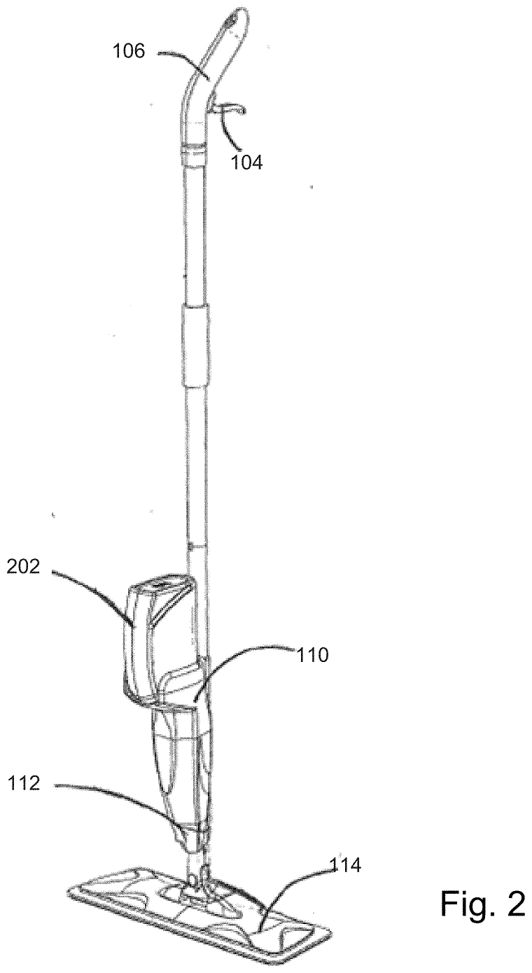

In one aspect, the bottle reservoir 110 on the lower pole section 106 may receive and retain a cleaning liquid bottle 202, as shown in FIG. 2, when the spray mop 100 is in use. The nozzle 112 may be generally directed forward and downward so that cleaning liquid drawn out of the bottle 202 and exiting the nozzle 112 is sprayed onto a surface in front of the mop 100. For example, depending upon the type of the flooring surface (e.g., marble, hardwood, or tile), a compatible bottled cleaning liquid may be selected and a bottle adapter may replace either the original bottle cap or a trigger sprayer of the cleaning product before it is inserted into the bottle reservoir 110.

When a user clenches the spray trigger 104, cleaning liquid may be drawn out of the bottle 202. The spray trigger 104 may be pivotably mounted to the handle 116 with a proximal end where it attaches the handle 116 and a distal end on the opposite side. The trigger 104 and handle 116 may be arranged such that a user's palm can rest on the top of the handle 116 and one or more of the user's fingers can clench the trigger 104 to pivot the distal end in a direction toward the handle 116. The distal end is in contact with an internal shaft (not shown), which is disposed within the upper and lower pole sections 102 and 106. As the distal end pivots during actuation of the trigger 104, it may depress the internal shaft to move it in a downward direction to open a valve of the bottle adaptor. As a result, the cleaning liquid stored in the bottle 202 is drawn out, exits the nozzle 112, and is sprayed onto the floor surface in front of the mop 100. When the user releases the spray trigger 104, the internal shaft may be moved upward by a reload spring and air enters the bottle 202 above the level of the cleaning liquid contained therein, thereby preventing the cleaning liquid from dripping from the bottle 202. Through this process, a flow path may be created in the mop 100 that can repeatedly direct cleaning liquid to flow from the bottle 202 and exit the bottle reservoir 110 through the nozzle 112 in response to each actuation of the spray trigger 104.

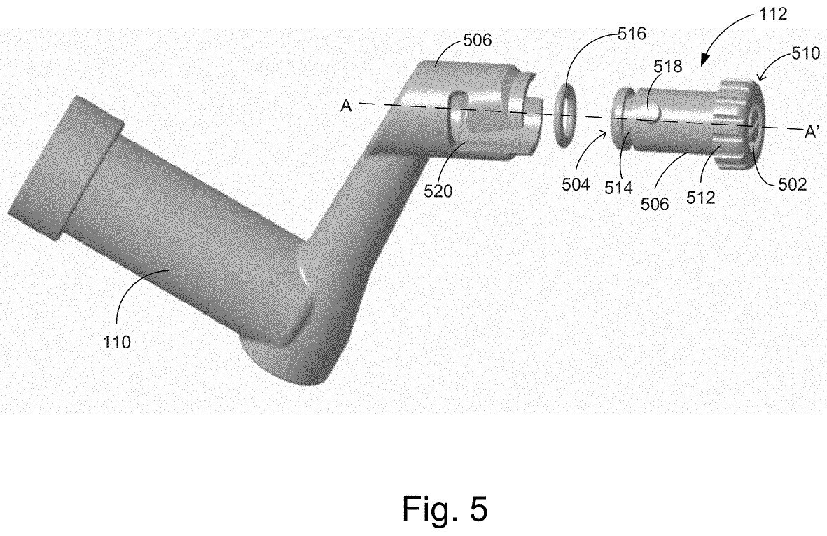

As shown in FIGS. 4 and 5, a water cover 402 may be disposed at the bottom portion of the housing of bottle reservoir 110 to carry the cleaning fluid from the bottle 202 through the valve of the bottle adaptor to the nozzle 112. The nozzle 112 may be configured with a geometry selected to atomize and emit liquid material for distribution in a desired spray pattern (e.g., a circular pattern, a flat pattern, or a fan pattern). Fluid passageways of the water cover 402 and nozzle 112 may generally have a circular cross section to allow easy assembly with one another. Although nozzle 112 described above is used on spray mop 100, it should be appreciated that nozzle 112 may be incorporated into any fluid spraying system that works with any fluid material including, but not limited to, for example, water, paint, primer, lacquers, liquid chemicals, etc.

In accordance with aspects of the present disclosure, nozzle 112 may be configured to be disposable, changeable and removable in order to accommodate the use of more viscous fluids or chemicals through a spraying system and replace nozzle for multiple uses. For example, nozzle 112 may be removed from its associated spraying system (e.g., spray mop 100) and replaced with a new nozzle by a user without difficulties or professional assistance, thereby providing an easy and simple way for the user to troubleshoot the corresponding spraying system if a full or partial blockage of the nozzle 112 occurs.

Nozzle 112 may have any suitable shape and structure to emit a spray through a nozzle opening 502 with a desired fluid distribution pattern on a floor surface for cleaning. In one embodiment, as shown in FIG. 5, nozzle 112 may generally include an inlet upstream end 504 configured to engage and connect with a fluid passageway 506 of water cover 402, a hollow cylindrical body 508, and an outlet downstream end 510 comprising the nozzle opening 502 and an outer cylindrical shell 512. A plurality of longitudinal ribs may be formed on the exterior of the outer cylindrical shell 512 to provide easy gripping and pulling thereof (e.g., positioning, rotation and detachment of nozzle 112). Moreover, the plurality of longitudinal ribs may facilitate convenient gripping of nozzle 112 with a wrench, plier or similar device if additional force may be needed to detach nozzle 112 from the underlying spraying system. Inlet upstream end 504 of nozzle 112 may comprise a circular groove 514 on the hollow cylindrical body 506 configured to receive an annular sealing member (e.g., an elastic O-ring seal 516). In one aspect, the relaxed inner diameter of the O-ring seal 516 may be slightly smaller than the diameter of the circular groove 514, and the O-ring seal 516 may be radially stretched to fit into the circular groove 514. The outside diameter of such a stretched O-ring seal 516 may be slight smaller than the inner diameter of fluid passageway 506 of water cover 402. As a result, when the nozzle 112 carries the O-ring seal 516 near its inlet upstream end 504 and is inserted into the fluid passageway 506 of water cover 402, the O-ring seal 514 may be tightly retained between the inner wall of the fluid passageway 506 of water cover 402 and the outer wall the hollow cylindrical body 506, thereby preventing liquid leakage therebetween and downstream therefrom.

In accordance with aspects of the present application, nozzle 112 may include attachment means configured to allow nozzle 112 to be removably coupled to the underlying spraying system. For example, as shown in FIGS. 1 and 2, disposable nozzle 112 may be made of a suitable chemical resistant plastic material such as polyvinylidene fluoride or polyvinylidene difluoride (PVDF) and positioned at a downstream outlet end of spray mop 100 for distributing cleaning fluid drawn out of the bottle 202 in a desired spray pattern onto a surface in front of the spray mop 100. In one embodiment, as shown in FIG. 5, a pair of radially extending and diametrically opposed stops 518 (only one is shown in FIG. 5) may be molded integrally with hollow cylindrical body 506 and disposed on a selected position on the outer surface of hollow cylindrical body 506 in the downstream direction of the sealing member 516. For securely receiving and retaining nozzle 112, the passageway 506 of water cover 402 may include a pair of diametrically spaced L-shaped slots 520. Each L-shaped slot 520 may have a first portion that is substantially parallel to the longitudinal axis AA′ of the passageway 506 of water cover 402 and a second portion implemented on the circumference of the passageway 506. Specifically, the first portion of each L-shaped slot 520 may have an opening for receiving each stop 518 when hollow cylindrical body 506 of nozzle 112 is inserted into the passageway 506 of water cover 402 and then rotated either clockwise or counterclockwise to move each stop 518 to contact an end wall of the second portion of each L-shaped slot 520. That is, proper orientation between the nozzle 112 and the passageway 506 of water cover 402 may be precisely determined when radially extending and diametrically opposed stops 518 are aligned with respective openings of first portions of slots 520. Subsequently, upon insertion of nozzle 112 into the passageway 506 of water cover 402 and rotation of the outer cylindrical shell 512 at the outlet downstream end 510 of nozzle 112, each stop 518 may reach against a respective end wall of the second portion of each L-shaped slot 520, thereby limiting any rotational movement of nozzle 112. In the meantime, the annular sealing member 516 installed on the circular groove 514 of the hollow cylindrical body 506 may also become compressed due to such insertion and rotation of nozzle 112. As a result, nozzle 112 may be locked and retained in its finally installed position with a tight seal engagement established to prevent any liquid leakage downstream therefrom. The circumferential distance or length of the second portion of each L-shaped slot 520 may be greater than or at least equal to that of each stop. The thickness of the cylindrical wall of the passageway 506 of water cover 402 may be configured to progressively decrease from its upstream end towards its downstream end. The height of each stop 518 of the hollow cylindrical body 506 measured in the radial direction may be less than or equal to the thickness of the end wall of the second portion of a respective L-shaped slot 520, thereby facilitating easy insertion and removal of nozzle 112 from the passageway 506 of water cover 402.

To replace nozzle 112, a user may grip and rotate the outer cylindrical shell 512 of nozzle 112 to slide the pair of radially extending and diametrically opposed stops 518 out of respective L-shaped slots 520. The annular sealing member 516 may be removed out of the passageway 506 of water cover 402 as a unit with nozzle 112.

Configurations of nozzle 112 and the passageway 506 of water cover 402 described herein may comprise a series of portions with geometric features configured to accommodate the use of, e.g., more viscous or harsh chemical solutions and provide an easy and simple way for a user to replace a clogged nozzle head. It should be appreciated that nozzle 112 and the passageway 506 of water cover 402 may be releasably coupled with each other using any suitable coupling technique (e.g., snap-fit engagement). As a result, connecting portions of nozzle 112 and the passageway 506 may meet at an interface such that fluid flows from one portion to another. At some interfaces, fluid may undergo a rapid expansion or contraction where radii of connecting portions are different. At other interfaces, radii of connecting portions may be substantially equal, such that expansion or contraction of fluid flow may be gradual. In another embodiment, nozzle 112 and/or the passageway of water cover 402 may be configured to have an internal diameter that decreases as cleaning fluid approaches the nozzle opening 502. The decrease in internal diameter may increase the velocity of the fluid exiting the nozzle opening 502.

The above description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure.

Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

1. A disposable nozzle, comprising:
a hollow cylindrical body having an inlet upstream end configured to receive a flow of liquid and an outlet downstream end for distributing the flow of liquid in a desired spray pattern; and
attachment means configured to removably couple the disposable nozzle to an spraying system.

2. The disposable nozzle of claim 1, wherein the attachment means are configured to removably couple the disposable nozzle to the spraying system via a fluid passageway of the spraying system, wherein an outer diameter of the hollow cylindrical body is less than an inner diameter of the fluid passageway of the spraying system.

3. The disposable nozzle of claim 1, further comprising a circular groove positioned near the inlet upstream end of the hollow cylindrical body for receiving an annular sealing member.

4. The disposable nozzle of claim 3, wherein the annular sealing member is configured to provide a tight seal engagement between the hollow cylindrical body and the fluid passageway of the spraying system and prevent liquid leakage downstream therefrom.

5. The disposable nozzle of claim 3, wherein the attachment means comprise a pair of radially extending and diametrically opposed stops positioned on a selected position on an outer surface of the hollow cylindrical body in a downstream direction of the annular sealing member.

6. The disposable nozzle of claim 5, wherein the fluid passageway of the spraying system comprises a pair of diametrically spaced L-shaped slots, each L-shaped slot including a first portion that is substantially parallel to a longitudinal axis of the fluid passageway and a second portion implemented on a circumference of the fluid passageway.

7. The disposable nozzle of claim 6, wherein the first portion of each L-shaped slot comprises an opening for receiving each of the pair of radially extending and diametrically opposed stops when the hollow cylindrical body of the disposable nozzle is inserted into the fluid passageway.

8. The disposable nozzle of claim 6, wherein the second portion of each L-shaped slot comprises an end wall for locking and retaining each of the pair of radially extending and diametrically opposed stops.

9. The disposable nozzle of claim 6, wherein a circumferential distance of the second portion of each L-shaped slot is greater than or at least equal to that of each of the pair of radially extending and diametrically opposed stops.

10. The disposable nozzle of claim 2, wherein a thickness of a cylindrical wall of the fluid passageway progressively decreases from an upstream end towards a downstream end.

11. The disposable nozzle of claim 8, wherein a height of each stop of the hollow cylindrical body in a radial direction is less than or equal to a thickness of the end wall of the second portion of a respective L-shaped slot.

12. The disposable nozzle of claim 1, wherein the outlet downstream end of the hollow cylindrical body comprises a nozzle opening for distributing the flow of liquid in the desired spray pattern.

13. The disposable nozzle of claim 1, wherein the outlet downstream end of the hollow cylindrical body comprises an outer cylindrical shell having a plurality of longitudinal ribs implemented thereon.

14. The disposable nozzle of claim 2, wherein the hollow cylindrical body of the disposable nozzle is configured to have an internal diameter progressively decreasing from the inlet upstream end to the outlet downstream end.
